(19) United States
(12) Patent Application Publication
(10) Pub. No.: US 2022/0201612 A1
(43) Pub. Date: Jun. 23, 2022

(54) FACILITATING WIRELESS COMMUNICATION FOR WEARABLE DEVICE

(71) Applicant: Facebook Technologies, LLC, Menlo Park, CA (US)

(72) Inventors: Insoo HWANG, Sammamish, WA (US); Kyungho KIM, San Jose, CA (US)

(21) Appl. No.: 17/132,126

(22) Filed: Dec. 23, 2020

(51) Int. Cl. H04W 52/02; H04W 52/36; H04W 52/24

(52) U.S. Cl. CPC H04W 52/0235; H04W 52/241; H04W 52/367; H04W 52/028

(57) ABSTRACT

Disclosed herein are related to a device that can facilitate wireless communication despite a contact of a user with the device. In one aspect, the device includes a wireless interface, a sensor, and a processor. In one aspect, the wireless interface is configure to communicate data with another device through a wireless communication link. In one aspect, the sensor is configured to detect whether the device is attached to a cradle. In one aspect, the processor is configured to determine whether the contact of the user with the device interferes with the wireless communication link, in response to determining that the device is detached from the cradle and/or determining at least one receive signal metric of the wireless interface. In one aspect, the processor is configured to initiate a process to facilitate communication of the data, in response to determining that the contact of the user with the device interferes with the wireless communication link.

### FIELD OF DISCLOSURE

The present disclosure is generally related to facilitating wireless communication for a wearable device, including but not limited to facilitating wireless communication in response to a user contact with the wearable device.

### BACKGROUND

Developments in computing devices and communication devices have prompted growth in wearable technology. Wearable devices may integrate various components in a compact form, such that the wearable devices can be portable yet perform complex processes. For example, a wearable device may be a smart watch that may access content over the network, and may control or communicate with other computing devices, etc. For example, a wearable device may be a head mounted display (HMD) that may present artificial reality (e.g., virtual reality, augmented reality, mixed reality, etc.).

### SUMMARY

Various embodiments disclosed herein are related to a device including a wireless interface, a sensor, and one or more processors. In some embodiments, the wireless interface is configured to communicate data with another device through a wireless communication link. In some embodiments, the sensor is configured to detect whether the device is attached to a cradle. In some embodiments, the one or more processors are coupled to the wireless interface and the sensor. In some embodiments, the one or more processors are configured to determine whether a contact of a user with the device interferes with the wireless communication link, in response to determining that the device is detached from the cradle and/or determining at least one receive signal metric of the wireless interface. In some embodiments, the one or more processors are configured to initiate a process to facilitate communication of the data, in response to determining that the contact of the user with the device interferes with the wireless communication link.

In some embodiments, the process includes providing, by the one or more processors, a message for the user to attach the device to the cradle. In some embodiments, the device further includes another wireless interface to communicate with the another device through another wireless communication link. In some embodiments, the process includes offloading, by the one or more processors, the communication of the data from the wireless interface to the another wireless interface, in response to determining that the device is detached from the cradle for a time period after presenting the message. In some embodiments, the process includes disabling the wireless interface, in response to determining that the device is detached from the cradle for a time period after presenting the message. In some embodiments, the one or more processors are further configured to resume the communication of the data through the wireless interface, in response to determining that the device is attached to the cradle after presenting the message.

In some embodiments, the sensor includes a hall sensor. In some embodiments, the one or more processors are configured to determine whether the contact of the user with the device interferes with the wireless communication link by comparing a first receive signal metric of the wireless communication link at a first time and a second receive signal metric of the wireless communication link at a second time after the first time. In some embodiments, the one or more processors are configured to determine whether the contact of the user with the device interferes with the wireless communication link by determining that the contact of the user with the device interferes with the wireless communication link, in response to the second receive signal metric being lower than the first receive signal metric by a threshold amount. In some embodiments, the one or more processors are configured to determine that the contact of the user with the device interferes with the wireless communication link, in response to an uplink transmit power of the wireless interface reaching or exceeding a defined transmit power level. In some embodiments, the one or more processors are configured to determine that the contact of the user with the device interferes with the wireless communication link, in response to detecting an A2 event.

Various embodiments disclosed herein are related to a method of facilitating communication of data of a device. In some embodiments, the method includes detecting, by a sensor of the device, whether the device is attached to a cradle. In some embodiments, the method includes determining, by one or more processors of the device, whether a contact of a user with the device interferes a wireless communication link, through which a wireless interface of the device is configured to communicate the data with another device, in response to determining that the device is detached from the cradle and/or determining at least one receive signal metric of the wireless interface. In some embodiments, the method includes initiating, by the one or more processors, a process to facilitate the communication of the data, in response to determining that the contact of the user with the device interferes with the wireless communication link.

In some embodiments, the process includes providing, by the one or more processors, a message for the user to attach the device to the cradle. In some embodiments, the process includes offloading, by the one or more processors, the communication of the data from the wireless interface to another wireless interface of the device, in response to determining that the device is detached from the cradle for a time period after presenting the message, the another wireless interface to communicate with the another device through another wireless communication link.

In some embodiments, the process includes disabling, by the one or more processors, the wireless interface, in response to determining that the device is detached from the cradle for a time period after presenting the message. In some embodiments, the one or more processors are further configured to resume the communication of the data through the wireless interface, in response to determining that the device is attached to the cradle after presenting the message.

In some embodiments, the sensor includes a hall sensor. In some embodiments, determining, by the one or more processors of the device, whether the contact of the user with the device interferes the wireless communication link includes comparing, by the one or more processors, a first receive signal metric of the wireless communication link at a first time and a second receive signal metric of the wireless communication link at a second time after the first time. In some embodiments, determining, by the one or more processors of the device, whether the contact of the user with the device interferes the wireless communication link includes determining, by the one or more processors, that the contact of the user with the device interferes with the wireless communication link, in response to the second receive signal metric being lower than the first receive signal metric by a threshold amount. In some embodiments, the one or more processors are configured to determine that the contact of the user with the device interferes with the wireless communication link, in response to an uplink transmit power of the wireless interface reaching or exceeding a defined transmit power level. In some embodiments, the one or more processors are configured to determine that the contact of the user with the device interferes with the wireless communication link, in response to detecting an A2 event.

Various embodiments disclosed herein are related to a non-transitory computer readable medium of a device. In some embodiments, the non-transitory computer readable medium stores instructions when executed by one or more processors cause the one or more processors to cause a sensor of the device to detect whether a device is attached to a cradle. In some embodiments, the non-transitory computer readable medium stores instructions when executed by the one or more processors cause the one or more processors to determine whether a contact of a user with the device interferes a wireless communication link, through which a wireless interface of the device is configured to communicate data with another device, in response to determining that the device is detached from the cradle and/or determining at least one receive signal metric of the wireless interface. In some embodiments, the non-transitory computer readable medium stores instructions when executed by the one or more processors cause the one or more processors to initiate a process to facilitate communication of the data, in response to determining that the contact of the user with the device interferes with the wireless communication link. In some embodiments, the process includes providing, by the one or more processors, a message for the user to attach the device to the cradle.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including wearable devices, according to an example implementation of the present disclosure.

FIG. 2 is a diagram of a wearable device, according to an example implementation of the present disclosure.

FIG. 3 is a diagram showing a perspective view of a head wearable display, according to an example implementation of the present disclosure.

FIG. 4A is a diagram showing a perspective view of a wearable device including a computing device attached to a cradle, according to an example implementation of the present disclosure.

FIG. 4B is a diagram showing a perspective view of a wearable device including a computing device detached from a cradle, according to an example implementation of the present disclosure.

FIG. 5 is a flowchart showing a process of initiating or bypassing a process of facilitating communication of data for a wearable device based on a user interaction with the wearable device, according to an example implementation of the present disclosure.

FIG. 6 is a flowchart showing an example process of facilitating communication of data for a wearable device, according to an example implementation of the present disclosure.

FIG. 7 is a block diagram of a computing environment according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are embodiments related to a device that can facilitate wireless communication despite a contact (e.g., holding in hand, with fingers and/or in palm) of a user with the device. The device may be part of a wearable device, a handheld device, or any mobile device that can communicate with another device through one or more wireless communication links. In one aspect, the device includes a wireless interface, a sensor, a processor, and a cradle. In one aspect, the wireless interface is configure to communicate data with another device through a wireless communication link. In one aspect, the sensor is configured to detect whether the device is attached to (e.g., latched/connected to, nestled/held in) a cradle (e.g., a socket, latch, connector, carrier, holder). The cradle may be a wearable component (e.g., wrist band), to which the device can be adaptively attached. In one aspect, in response to determining that the device is detached (e.g., separated, disconnected) from the cradle, the processor may determine whether the contact of the user with the device interferes with the wireless communication link (e.g., blocks/shields/attenuates signals to/from some portion of an antenna or receiving/transmitting interface). In response to determining that the contact of the user with the device interferes with the wireless communication link, the processor may initiate a process to facilitate communication of the data. An example process to facilitate communication includes providing or presenting a message for the user to attach the device to the cradle and/or for the user to reposition one or more fingers (and/or any part of the user's hand or palm) relative to the device (e.g., from a current position on or in contact with the device, to another position) to improve signal quality (e.g., so as to avoid/minimize the interference, and/or so that the user's physical contact with the device, or a certain portion of the device, is minimized or avoided). An example process to facilitate communication includes offloading (e.g., re-directing, or moving the functionality of) communication of data from the wireless interface to another wireless interface.

Advantageously, wireless communication for a device can help maintain wireless communication if the contact of the user with the wearable device causes interference with or negatively impacts the wireless communication. In one aspect, a user may contact (e.g., hold, grasp) the device, for example, to provide input, perform operation, point/direct the device, capture an image, etc. However, such contact may interfere with a wireless communication of the device. In case the device is detached from the cradle and the wireless link quality degrades due to the contact or interference, the device may present a message for the user to attach/re-attach the device to the cradle or present a message for the user to reposition one or more fingers (e.g., away from certain portion(s) of the device, and/or to move to/towards other portion(s) of the device) to improve signal quality. By attaching the device to the cradle, interference due to the user contact can be reduced or avoided, such that the wireless link quality can be improved. Alternatively, or in case the wireless link quality does not improve for a time period despite the message, the device may offload the communication of data to another wireless interface.

Although various embodiments disclosed herein are provided with respect to wearable devices, principles disclosed herein can be applied to other handheld devices (e.g., smart phones, tablet computers, laptops, etc.).

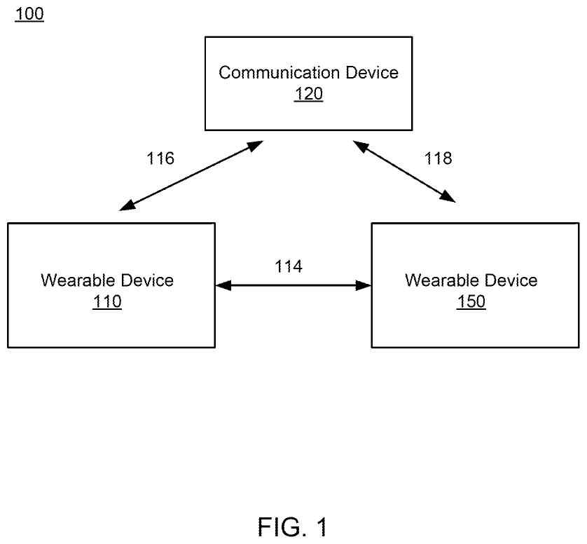

FIG. 1 is a block diagram of an example system 100. In some embodiments, the system 100 includes a communication device 120, a wearable device 110, and a wearable device 150. The wearable device 110 may be a smart watch, and the wearable device 150 may be a head wearable device (HWD) 150. The communication device 120 may be an access point or any other communication device. The HWD 150 may be referred to as, include, or be part of a head mounted display (HMD), head mounted device (HMD), head worn display (HWD) or head worn device (HWD). The wearable device 110 and the HWD 150 may communicate with each other through a communication link 114. The wearable device 110 and the communication device 120 may communicate with each other through a communication link 116, and the wearable device 150 and the communication device 120 may communicate with each other through a communication link 118. Through the wireless links 116, 118, the wearable devices 110, 150 may access content (e.g., text, image, audio, video, etc.) from other devices. The communication links 114, 116, 118 may be wireless links (e.g., cellular link, Wi-Fi link, Bluetooth link, 60 GHz link, ultra wideband link, etc.). The communication links 114, 116, 118 may be based on the same protocol or different protocols. For example, the communication links 116, 118 may conform to the 3G, 4G, 5G, LTE, 60 GHz protocol, where the communication link 114 may conform to the Wi-Fi link, Bluetooth, etc. In some embodiments, the system 100 includes more, fewer, or different components than shown in FIG. 1.

In one aspect, the wearable device 110 and the wearable device 150 may operate together to provide/support artificial reality for a user. In one example, the wearable device 150 may detect a location and an orientation of the wearable device 150, and generate a sensor measurement indicating the detected location and orientation of the wearable device 150. The wearable device 150 may transmit the sensor measurement to the wearable device 110 through the communication link 114. The wearable device 110 may receive the sensor measurement, and may generate or determine a view of the artificial reality corresponding to the detected location and orientation of the wearable device 150. The wearable device 110 may generate image data of the determined view of the artificial reality, and transmit the image data to the wearable device 150 through the communication link 114. The HWD 150 may receive the image data, and can present an image of the artificial reality to a user according to the image data. In one aspect, the process of detecting the location and the orientation of the HWD 150, and rendering the image to the user should be performed within a frame time (e.g., 11 ms or 16 ms). Any latency between a movement of the user wearing the HWD and an image displayed corresponding to the user movement can cause judder, which may result in motion sickness and can degrade the user experience.

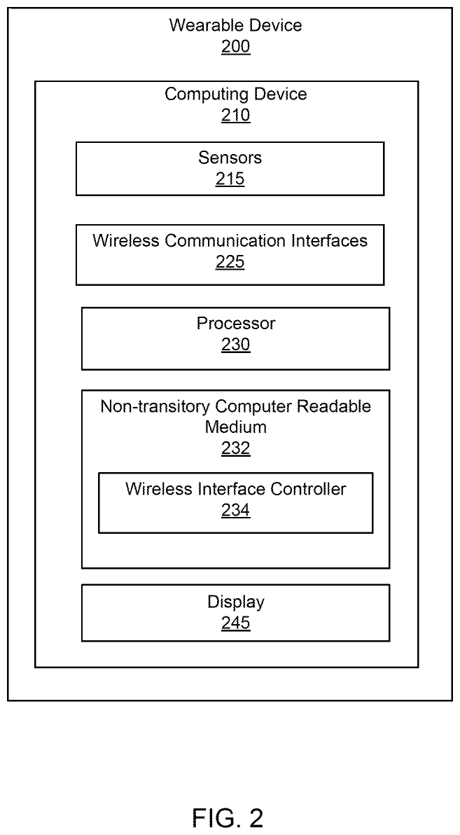

FIG. 2 is a diagram of a wearable device 200, according to an example implementation of the present disclosure. In some embodiments, the wearable device 200 may be the wearable device 110 or the wearable device 150. In some embodiments, the wearable device 200 includes a computing device 210 and a cradle (not shown in FIG. 2), to which the computing device 210 can be selectively attached. In some embodiments, the computing device 210 includes sensors 215, wireless communication interfaces 225 (also referred to as “wireless interfaces 225” herein), processor 230, non-transitory computer readable medium 232, and a display 245. These components may operate together to communicate with another device, and generate or render content (e.g., artificial reality content). In other embodiments, the wearable device 200 includes more, fewer, or different components than shown in FIG. 2.

In some embodiments, the sensors 215 include electronic components or a combination of electronic components and software components that detect a proximity of a user wearing the wearable device 200. For example, the sensors 215 can include a hall sensor that can detect whether the user is proximate (e.g., less than 10 mm) to the sensor or whether the user is contacting the computing device 210 (e.g., contacting and/or blocking a certain component of the device used/configured for wireless communication). The sensors 215 may detect a proximity of the user with respect to the computing device 210, and can generate a sensor measurement data indicating the detected proximity.

In some embodiments, the sensors 215 include electronic components or a combination of electronic components and software components that can operate to sense/determine/measure a location and/or an orientation of the computing device 210. Examples of the sensors 255 can include: one or more imaging sensors, one or more accelerometers, one or more gyroscopes, one or more magnetometers, or any other suitable type of sensor(s) that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 215 detect the translational movement and the rotational movement, and determine an orientation and location of the computing device 210. The sensors 215 may generate sensor measurements indicating the detected location and orientation of the computing device 210.

In some embodiments, wireless communication interfaces 225 include electronic components or combinations of electronic components and software components that communicate with another device through wireless communication links (e.g., communication link 114, 116, 118). In some embodiments, the wireless communication interfaces 225 include a wireless interface for a cellular communication link (e.g., 3G, 4G, LTE communication link). The wireless communication interfaces 225 ma also include a wireless interface for a different communication link (e.g., Wi-Fi or Bluetooth communication link). In some embodiments, wireless communication interfaces 225 include or are embodied as transceivers or communication modems coupled to the transceivers for transmitting and receiving data through wireless mediums. The wireless communication interfaces 225 may transmit or receive sensor measurement data indicating locations and orientations of the computing device 210. Moreover, the wireless communication interface 225 may transmit or receive image data indicating or corresponding to images to be rendered.

In some embodiments, the processor 230 includes an electronic component or a combination of an electronic component that can execute instructions stored by the non-transitory computer readable medium 232. The processor 230 may include one or more central processing units (CPUs), graphical processing units (GPUs) or a combination of them. The non-transitory computer readable medium 232 may store instructions for executing one or more applications executable by the processor 230.

One example application when executed by the processor 230 may cause the processor 230 to generate or process content for rendering. The processor 230 executing the application may cause the processor 230 to generate image data for rendering, according to sensor measurement data from the sensors 215 or the wireless communication interfaces 225. For example, the processor 230 executing the application may determine a view of the artificial reality corresponding to detected location and orientation in the sensor measurement data and generate image data of the determined view of the artificial reality.

Example applications when executed by the processor 230 may cause the processor 230 to control or adjust the wireless communication interface 225. Example applications include wireless interface controller 234. The wireless interface controller 234 may be executed by the processor 230 to detect whether the computing device 210 is attached to a cradle. In response to determining that the computing device 210 is detached from the cradle, the processor 230 executing the wireless interface controller 234 may determine whether the contact of the user with the computing device 210 interferes with the wireless communication link or not. In response to determining that the contact of the user with the computing device 210 interferes with the wireless communication link, the processor 230 executing the wireless interface controller 234 may initiate a process to facilitate communication of the data.

In one aspect, the processor 230 receives a sensor measurement indicating whether the computing device 210 is attached to or detached from a cradle. For example, the sensor 215 includes a hall sensor or any electrical sensor that can generate a sensor measurement indicating whether the computing device 210 is attached to or detached from a cradle. According to the sensor measurement, the processor 230 may determine whether a user contact with the computing device 210 degrades the signal quality of the wireless communication link or not. For example, in response to the sensor measurement indicating that the computing device 210 is attached to the cradle, the processor 230 may determine whether the user contact with the computing device 210 degrades the signal quality of the wireless communication link or not. For example, in response to the sensor measurement indicating that the computing device 210 is not detached from the cradle, the processor 230 may bypass or skip determining whether the user contact with the computing device 210 degrades the signal quality of the wireless communication link or not.

In one approach, the processor 230 may determine whether a user contact with the computing device 210 degrades the signal quality of the wireless communication link or not, according to a receive signal metric of the wireless communication interface 225. An example receive signal metric includes reference signals received power (RSRP), reference signal received quality (RSRQ), etc. To determine whether the user contact with the computing device 210 degrades the signal quality of the wireless communication link or not, the processor 230 may compare a first receive signal metric of the wireless communication link at a first time and a second receive signal metric of the wireless communication link at a second time after the first time. For example, in response to determining that the second receive signal metric is worse or lower than the first receive signal metric by an amount larger than a threshold amount, the processor 230 may determine that the user contact with the computing device 210 degrades the signal quality of the wireless communication link. The threshold amount may be adjustable or reconfigurable. In response to determining that the second receive signal metric is worse or lower than the first receive signal metric by an amount less than the threshold amount (e.g., within a defined time period, which may include the first time and the second time), the processor 230 may determine that the user contact with the computing device 210 does not degrade the signal quality of the wireless communication link.

In one approach, the processor 230 may determine whether the user contact with the computing device 210 degrades the signal quality of the wireless communication link or not, according to an uplink transmit power level of the wireless communication interface 225. For example, the processor 230 may determine that the user contact with the computing device 210 degrades or reduces the signal quality of the wireless communication link, in response to an uplink transmit power of the wireless interface reaching or exceeding a defined transmit power level. The processor 230 may determine that the user contact with the computing device 210 degrades the signal quality of the wireless communication link, in response to i) determining that the second receive signal metric is worse or lower than the first receive signal metric by an amount larger than the threshold amount, and ii) determining that the uplink transmit power of the wireless interface reaches or exceeds a defined transmit power level. Based on the sudden drop in the receive signal metric (e.g., according to the defined time period, and/or the first time and the second time), an increased transmit power level, and/or the computing device 210 being detached from the cradle, the processor 230 may infer or determine with a high accuracy/certainty that the user contact with the computing device 210 has degraded the signal quality of the wireless communication link.

In one approach, the processor 230 may determine whether the user contact with the computing device 210 degrades the signal quality of the wireless communication link or not, according to a user equipment measurement reporting event. The user equipment measurement reporting event may be a reporting event for cellular protocols (e.g., LTE, etc.). For example, the processor 230 may determine that the user contact with the computing device 210 degrades the signal quality of the wireless communication link, in response to detecting an A2 event (serving becomes worse than threshold). The processor 230 may determine that the user contact with the computing device 210 degrades the signal quality of the wireless communication link, in response to i) determining that the second receive signal metric is worse or lower than the first receive signal metric by an amount larger than the threshold amount, and/or ii) detecting the A2 event. Based on the sudden drop in the receive signal metric, detecting the A2 event, and/or the computing device 210 being detached from the cradle, the processor 230 may infer or determine that the user contact with the computing device 210 has degraded the signal quality of the wireless communication link, with a high accuracy/certainty.

In response to determining that the contact of the user with the computing device 210 interferes with the wireless communication link, the processor 230 may provide or present, for example through the display 245, a message for the user to attach the computing device 210 to the cradle. An example message includes “Cellular service will be limited. For best experience, please place device on cradle.” In response to determining that the contact of the user with the computing device 210 interferes with the wireless communication link, the processor 230 may provide or present, for example through the display 245, a message for the user to reposition fingers to improve signal quality. If the receive signal quality metric does not improve (and/or the device does not detect that it is in the cradle) within a predetermined time period (10 seconds) after presenting the message, the processor 230 executing the wireless interface controller 234 may offload communication of data from one wireless interface 225 (e.g., wireless interface for a cellular communication link such as LTE communication link) to another wireless interface 225 (e.g., wireless interface for Wi-Fi or Bluetooth communication link). In some embodiments, if the receive signal quality metric does not improve within the predetermined time period after presenting the message, the processor 230 may request, for example through the display 245, a confirmation to offload the communication of data to another wireless interface 225, and offload the communication upon receiving the confirmation from the user. In some embodiments, if the receive signal quality metric does not improve (and/or the device does not detect that it is in the cradle) within the predetermined time period after presenting the message, the wireless interface controller 234 may automatically offload communication of data from one wireless interface 225 to another wireless interface 225 to provide seamless communication of data. In some embodiments, (e.g., if the receive signal quality metric does not improve within the predetermined time period after presenting the message and/or if there is no additional wireless communication interface to offload communication of data) the processor 230 may disable the wireless interface to conserve power.

In some embodiments, the display 245 is an electronic component that displays an image. The display 245 may, for example, be a liquid crystal display or an organic light emitting diode display. The display 245 may be a touch screen display. The display 245 may be a transparent display that allows the user to see through.

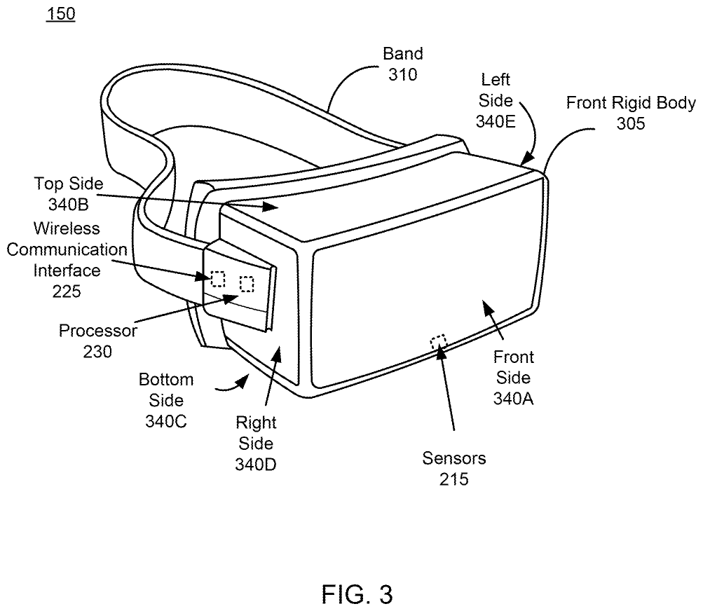

FIG. 3 is a diagram of the HWD 150, in accordance with an example embodiment. In some embodiments, the HWD 150 includes a front rigid body 305 and a band 310. The front rigid body 305 includes the display 245 (not shown in FIG. 3), lens (not shown in FIG. 3), the sensors 215, the wireless communication interface 225, and the processor 230. In the embodiment shown by FIG. 3, the wireless communication interface 225, the processor 230, and the sensors 215 are located within the front rigid body 205, and may not be visible to the user. In other embodiments, the HWD 150 has a different configuration than shown in FIG. 3. For example, the wireless communication interface 225, the processor 230, and/or the sensors 215 may be in different locations than shown in FIG. 3.

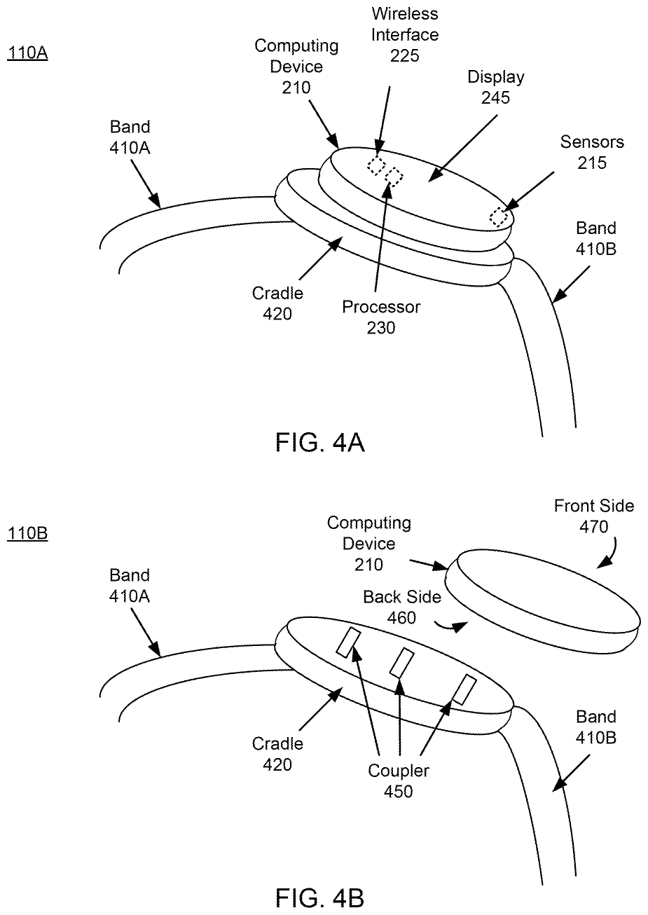

FIG. 4A is a diagram showing a perspective view of the wearable device 110A including a computing device 210 attached to a cradle 420, according to an example implementation of the present disclosure. The processor 230, the wireless communication interface 225 and the sensors 215 may be disposed within a housing of the computing device 210, such that the processor 230, the wireless communication interface 225 and the sensors 215 may not be visible to the user. The computing device 210 may also include the display 245 on a front side 470 to present text or image. The computing device 210 may be detachable from the cradle 420 as shown in FIG. 4B. The computing device 210 may be detached from the cradle 420 to allow the user to charge the battery of the computing device 210, connect to another device through a cable, or capture an image, etc. The cradle 420 may be a wearable structure or a component to selectively hold, contain, connect, grasp and/or couple the computing device 210. The cradle 420 may include one or more couplers 450, to which a back side 460 or other portion of the computing device 210 can be attached. One or more couplers 450 may include mechanical latches, magnetics, hook and loop fasteners, or any component(s) that allow the cradle 420 to selectively hold or couple the computing device 210. The cradle 420 may include or may be attached to wrist bands 410A, 420B.

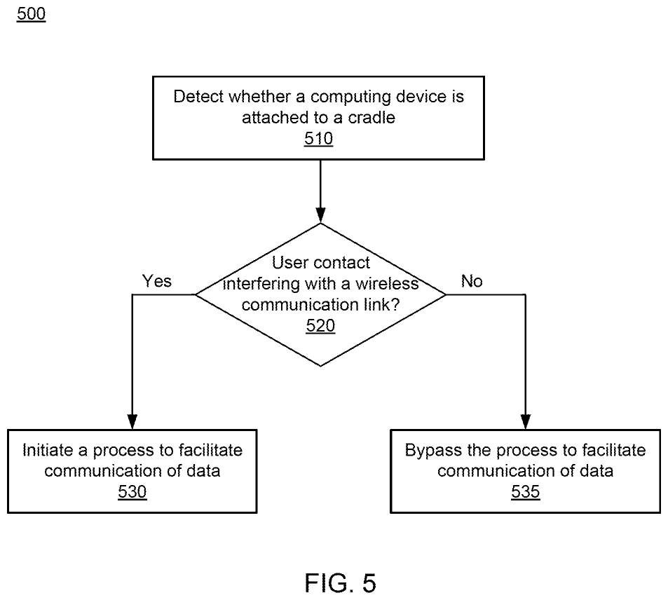

FIG. 5 is a flowchart showing a process 500 of initiating or bypassing a process of facilitating communication of data for a wearable device based on a user interaction with the wearable device (e.g., wearable device 110 or wearable device 150), according to an example implementation of the present disclosure. In some embodiments, the process 500 is performed by the wearable device 110 or the wearable device 150. In some embodiments, the process 500 is performed by other entities. In some embodiments, the process 500 includes more, fewer, or different steps than shown in FIG. 5.

In one approach, the wearable device detects 510 whether a computing device (e.g., computing device 210) is attached to a cradle or not. The computing device may include a sensor (e.g., hall sensor or any electrical sensor) that can detect whether the computing device is attached to the cradle or not. Based on the sensor measurement, the wearable device may detect whether the computing device is attached to the cradle or not.

In one approach, in response to detecting that the computing device is detached from the cradle, the wearable device determines 520 whether a user contact interferes with a wireless communication link. The wearable device may determine whether the user contact interferes with the wireless communication link, according to the receive signal metric (e.g., RSRP, RSRQ) of the wireless communication interface 225. The wearable device may perform measurement(s) of the receive signal metric, and/or monitor the measurement(s) over time. The wearable device may also determine whether the user contact interferes with the wireless communication link, according to an uplink transmit power level of the wireless communication interface 225, user equipment measurement reporting event, or both. For example, the wearable device may determine that the user contact with the computing device 210 degrades the signal quality of the wireless communication link, in response to i) determining that the second receive signal metric is worse or lower than the first receive signal metric by an amount larger than the threshold amount, and/or ii) determining that the uplink transmit power of the wireless interface reaches or exceeds a defined transmit power level. For example, the wearable device may determine that the user contact with the computing device 210 degrades the signal quality of the wireless communication link, in response to i) determining that the second receive signal metric is worse or lower than the first receive signal metric by an amount larger than the threshold amount, and/or ii) detecting the A2 event. Based on various factors or measurements, the wearable device may infer or determine that the user contact with the computing device 210 degrades the signal quality of the wireless communication link, with a high accuracy/certainty.

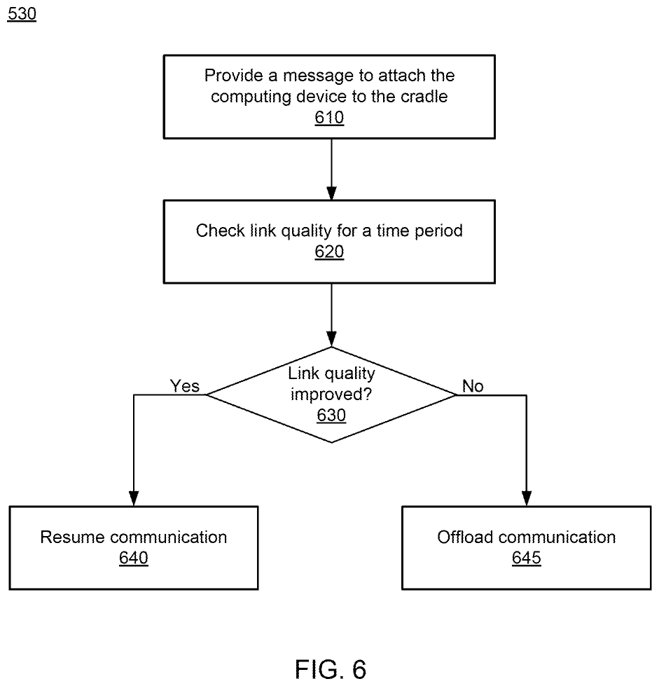

In response to determining that the contact of the user with the computing device 210 interferes with the wireless communication link, the wearable device may initiate 530 a process to facilitate communication of the data. In response to determining that the contact of the user with the computing device 210 does not interfere with the wireless communication link, the wearable device may bypass 535 the process to facilitate communication of the data. An example of the process 530 is provided below with respect to FIG. 6.

FIG. 6 is a flowchart showing an example process 530 to facilitate communication of data for a wearable device (e.g., wearable device 110 or wearable device 150), according to an example implementation of the present disclosure. In some embodiments, the process 530 is performed by other entities. In some embodiments, the process 530 includes more, fewer, or different steps than shown in FIG. 6.

In one approach, the wearable device presents or provides 610 a message (or a notification) to attach computing device to the cradle or reposition one or more fingers (and/or any portion of the hand or palm) to improve signal quality, in response to determining that the user contact interferes with a wireless communication link. In one approach, the wearable device may monitor or check 620 the quality of the wireless communication link for a predetermined time period (e.g., 10 seconds). For example, the wearable device may monitor or check the RSRP or RSRQ for the predetermined time period after providing the message. The wearable device may determine 630 whether the quality of the wireless communication link is improved within the predetermined time period after presenting the message. In response to determining that the quality of the wireless communication link is improved within the predetermined time period after providing the message, the wearable device may resume 640 communication through the wireless communication link.

In response to determining that the quality of the wireless communication link is not improved within the predetermined time period after providing the message, the wearable device may determine whether another wireless communication interface (e.g., a wireless interface for Wi-Fi or Bluetooth communication link) is available. If another wireless communication interface is available, the wearable device may offload communication of data to the another wireless interface. In one approach, if the quality of the wireless communication link does not improve within the predetermined time period after presenting the message, the wearable device may provide a request to a user, for example through the display 245, a confirmation to offload the communication of data to another wireless interface 225, and offload the communication upon receiving the confirmation from the user. In one approach, if the quality of the wireless communication link does not improve within the predetermined time period after presenting the message, the wearable device may automatically offload communication of data from one wireless interface 225 to another wireless interface 225 to provide seamless communication. If the quality of the wireless communication link does not improve within the predetermined time period after presenting the message and if there is no additional wireless communication interface to offload communication of data, the wearable device may disable the wireless interface to conserve power.

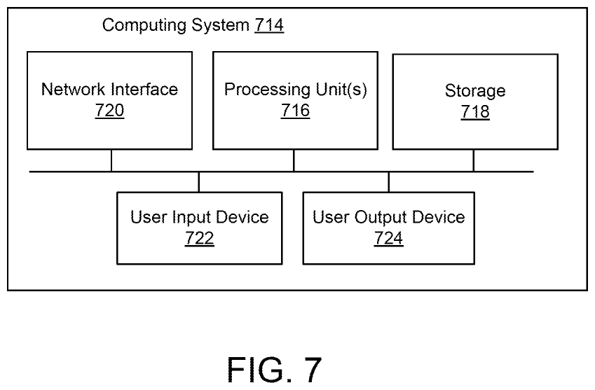

Various operations described herein can be implemented on computer systems. FIG. 7 shows a block diagram of a representative computing system 714 usable to implement the present disclosure. In some embodiments, the wearable device 110, the wearable device 150 or both of FIG. 1 are implemented by the computing system 714. Computing system 714 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 714 can be implemented to provide VR, AR, MR experience. In some embodiments, the computing system 714 can include conventional computer components such as processors 716, storage device 718, network interface 720, user input device 722, and user output device 724.

Network interface 720 can provide a connection to a wide area network (e.g., the Internet) to which WAN interface of a remote server system is also connected. Network interface 720 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 722 can include any device (or devices) via which a user can provide signals to computing system 714; computing system 714 can interpret the signals as indicative of particular user requests or information. User input device 722 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 724 can include any device via which computing system 714 can provide information to a user. For example, user output device 724 can include a display to display images generated by or delivered to computing system 714. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 724 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 716 can provide various functionality for computing system 714, including any of the functionality described herein as being performed by a server or client, or other functionality associated with message management services.

It will be appreciated that computing system 714 is illustrative and that variations and modifications are possible. Computer systems used in connection with the present disclosure can have other capabilities not specifically described here. Further, while computing system 714 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’″ can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device comprising:
a wireless interface configured to communicate data with another device through a wireless communication link;
a sensor configured to detect whether the device is attached to a cradle; and
one or more processors coupled to the wireless interface and the sensor, the one or more processors configured to:
determine whether a contact of a user with the device interferes with the wireless communication link, in response to determining that the device is detached from the cradle, and
initiate a process to facilitate communication of the data, in response to determining that the contact of the user with the device interferes with the wireless communication link.

2. The device of claim 1, wherein the process includes providing, by the one or more processors, a message for the user to attach the device to the cradle, or to reposition one or more fingers relative to the device.

3. The device of claim 2, further comprising:
another wireless interface to communicate with the another device through another wireless communication link,
wherein the process includes offloading, by the one or more processors, the communication of the data from the wireless interface to the another wireless interface, in response to determining that the device is detached from the cradle for a time period after presenting the message.

4. The device of claim 2, wherein the process includes disabling the wireless interface, in response to determining that the device is detached from the cradle for a time period after presenting the message.

5. The device of claim 4, wherein the one or more processors are further configured to resume the communication of the data through the wireless interface, in response to determining that the device is attached to the cradle after presenting the message.

6. The device of claim 1, wherein the sensor includes a hall sensor.

7. The device of claim 1, wherein the one or more processors are configured to determine whether the contact of the user with the device interferes with the wireless communication link by:
comparing a first receive signal metric of the wireless communication link at a first time and a second receive signal metric of the wireless communication link at a second time after the first time, and
determining that the contact of the user with the device interferes with the wireless communication link, in response to the second receive signal metric being lower than the first receive signal metric by a threshold amount.

8. The device of claim 7, wherein the one or more processors are configured to determine that the contact of the user with the device interferes with the wireless communication link, in response to an uplink transmit power of the wireless interface reaching or exceeding a defined transmit power level.

9. The device of claim 7, wherein the one or more processors are configured to determine that the contact of the user with the device interferes with the wireless communication link, in response to detecting an A2 event.

10. A method comprising:
detecting, by a sensor of a device, whether the device is attached to a cradle;
determining, by one or more processors of the device, whether a contact of a user with the device interferes a wireless communication link, through which a wireless interface of the device is configured to communicate data with another device, in response to determining that the device is detached from the cradle; and
initiating, by the one or more processors, a process to facilitate communication of the data, in response to determining that the contact of the user with the device interferes with the wireless communication link.

11. The method of claim 10, wherein the process includes providing, by the one or more processors, a message for the user to attach the device to the cradle, or to reposition one or more fingers relative to the device.

12. The method of claim 11, wherein the process includes offloading, by the one or more processors, the communication of the data from the wireless interface to another wireless interface of the device, in response to determining that the device is detached from the cradle for a time period after presenting the message, the another wireless interface to communicate with the another device through another wireless communication link.

13. The method of claim 11, wherein the process includes disabling, by the one or more processors, the wireless interface, in response to determining that the device is detached from the cradle for a time period after presenting the message.

14. The method of claim 13, wherein the one or more processors are further configured to resume the communication of the data through the wireless interface, in response to determining that the device is attached to the cradle after presenting the message.

15. The method of claim 10, wherein the sensor includes a hall sensor.

16. The method of claim 10, wherein determining, by the one or more processors of the device, whether the contact of the user with the device interferes the wireless communication link includes:
comparing, by the one or more processors, a first receive signal metric of the wireless communication link at a first time and a second receive signal metric of the wireless communication link at a second time after the first time, and
determining, by the one or more processors, that the contact of the user with the device interferes with the wireless communication link, in response to the second receive signal metric being lower than the first receive signal metric by a threshold amount.

17. The method of claim 16, wherein the one or more processors are configured to determine that the contact of the user with the device interferes with the wireless communication link, in response to an uplink transmit power of the wireless interface reaching or exceeding a defined transmit power level.

18. The method of claim 16, wherein the one or more processors are configured to determine that the contact of the user with the device interferes with the wireless communication link, in response to detecting an A2 event.

19. A non-transitory computer readable medium of a device, the non-transitory computer readable medium storing instructions when executed by one or more processors cause the one or more processors to:
cause a sensor of the device to detect whether a device is attached to a cradle;
determine whether a contact of a user with the device interferes a wireless communication link, through which a wireless interface of the device is configured to communicate data with another device, in response to determining that the device is detached from the cradle; and
initiate a process to facilitate communication of the data, in response to determining that the contact of the user with the device interferes with the wireless communication link.

20. The non-transitory computer readable medium of claim 19, wherein the process includes providing, by the one or more processors, a message for the user to attach the device to the cradle.
